(19) United States
(12) Patent Application Publication
(10) Pub. No.: US 2025/0328997 A1
(43) Pub. Date: Oct. 23, 2025

(54) PROXY-GUIDED IMAGE EDITING

(71) Applicant: ADOBE INC., SAN JOSE, CA (US)

(72) Inventors: Yuqian Zhou, Redmond, WA (US); Krishna Kumar Singh, San Jose, CA (US); Zhe Lin, Clyde Hill, WA (US)

(21) Appl. No.: 18/956,284

(22) Filed: Nov. 22, 2024

Related U.S. Application Data
(60) Provisional application No. 63/637,748, filed on Apr. 23, 2024.

(51) Int. Cl. G06T 5/77; G06T 5/70; G06T 7/11; G06T 11/00; G06V 10/774

(52) U.S. Cl. CPC G06T 5/77; G06T 5/70; G06T 7/11; G06T 11/00; G06V 10/774; G06T 2200/24; G06T 2207/20016; G06T 2207/20081; G06T 2207/20084; G06T 2210/36

(57) ABSTRACT

A method, apparatus, non-transitory computer readable medium, and system for image processing include obtaining an input image and an input mask, wherein the input mask indicates a region of the input image to be modified and generating, using a first image generation model, an intermediate result based on the input image and the input mask, wherein the intermediate result modifies the region of the input image indicated by the input mask. A second image generation model generates a synthetic image based on the input image and the intermediate result, wherein the synthetic image depicts the input image with content from the modified region at a higher level of detail than the intermediate result.

### CROSS-REFERENCE TO RELATED APPLICATION

This application claims priority under 35 U.S.C. § 119 to U.S. Provisional Application No. 63/637,748, filed on Apr. 23, 2024, in the United States Patent and Trademark Office, the disclosure of which is incorporated by reference herein in its entirety.

### BACKGROUND

The following relates generally to image processing, and more specifically to image editing using a machine learning model. Image processing refers to the use of a computer to edit an image using an algorithm or a processing network. In some cases, image processing software can be used for various image processing tasks, such as image restoration, image detection, image generation, image compositing, and image editing.

In some cases, image editing includes the use of a machine learning model to edit an input image based on a conditioning to generate an output image. For example, the machine learning model is trained to generate an edited image based on a text prompt, a mask input, and/or an input image. In some cases, the edited image may depict a modification to the input image, such as a removal of an element from the input image.

### SUMMARY

Aspects of the present disclosure provide a method and system for image generation. In one aspect, the system receives an input image and an input mask and generates an edited image based on the input image and the input mask. In one aspect, the system includes a first image generation model trained to generate a proxy guidance based on a lower resolution input. The proxy guidance is used as input to a second image generation model to guide the image generation process. In one aspect, the system includes a teacher image generation model trained to remove an element from the input image. In one aspect, the first image generation model is trained using the distillated knowledge from the teacher image generation model to generate the proxy guidance. In one aspect, a second image generation model generates a synthetic image based on the input image, the input mask, and the proxy guidance. In one aspect, one or more elements are removed from the input image and the result is depicted in the synthetic image. In one aspect, the input image and the synthetic image are high-resolution images.

A method, apparatus, non-transitory computer readable medium, and system for image processing include obtaining an input image and an input mask, wherein the input mask indicates a region of the input image to be modified; generating, using a first image generation model, an intermediate result based on the input image and the input mask, wherein the intermediate result modifies the region of the input image indicated by the input mask; and generating, using a second image generation model, a synthetic image based on the input image and the intermediate result, wherein the synthetic image depicts the input image with content from the modified region at a higher level of detail than the intermediate result.

A method, apparatus, non-transitory computer readable medium, and system for image processing include obtaining an input image and an input mask, wherein the input mask indicates an element of the input image to be removed; generating, using a first image generation model, an intermediate result based on the input image and the input mask, wherein the intermediate result removes the element of the input image indicated by the input mask; and generating, using a second image generation model, a synthetic image based on the input image and the intermediate result, wherein the synthetic image depicts the input image without the element removed in the intermediate result.

A method, apparatus, non-transitory computer readable medium, and system for training a machine learning model include obtaining a training set comprising an input image including an element, generating, using a teacher image generation model, a predicted image that replaces the element from the input image with generated content, and training, using the training set and the predicted image, a first image generation model to replace the element from the input image with the generated content.

An apparatus and system for image processing include a memory component and a processing device coupled to the memory component, the processing device configured to perform operations comprising: obtaining an input image and an input mask, wherein the input image depicts an element and the input mask indicates a region of the element in the input image, generating, using a first image generation model, an intermediate result based on the input image and the input mask, wherein the intermediate result includes first generated content in place of the element within the region indicated by the input mask, and generating, using a second image generation model, a synthetic image based on the input image and the intermediate result, wherein the synthetic image includes second generated content in place of the element within the region indicated by the input mask.

### BRIEF DESCRIPTION OF THE DRAWINGS

FIG. 1 shows an example of an image processing system according to aspects of the present disclosure.

FIG. 2 shows an example of a method for image editing according to aspects of the present disclosure.

FIGS. 3, 4, and 5 show examples of object removal using proxy guidance according to aspects of the present disclosure.

FIG. 6 shows an example of a method for image editing based on a proxy guidance according to aspects of the present disclosure.

FIG. 7 shows an example of an image processing apparatus according to aspects of the present disclosure.

FIG. 8 shows an example of a machine learning model according to aspects of the present disclosure.

FIG. 9 shows an example of an object removal system according to aspects of the present disclosure.

FIG. 10 shows an example of an image generation model according to aspects of the present disclosure.

FIG. 11 shows an example of a U-Net architecture according to aspects of the present disclosure.

FIG. 12 shows an example of a diffusion process according to aspects of the present disclosure.

FIG. 13 shows an example of a method for training a machine learning model according to aspects of the present disclosure.

FIG. 14 shows an example of training a machine learning model according to aspects of the present disclosure.

FIG. 15 shows an example of a flow diagram depicting an algorithm as a step-by-step procedure in an example implementation of operations performable for training a machine learning model according to aspects of the present disclosure.

FIG. 16 shows an example of a method for training a diffusion model according to aspects of the present disclosure.

FIG. 17 shows an example of a computing device according to aspects of the present disclosure.

### DETAILED DESCRIPTION

Aspects of the present disclosure relate to image editing using generative machine learning. Some embodiments of the disclosure relate to an image generation system that accurately and efficiently generate a synthetic image that depicts a modification (e.g., removal) of an image element from an input image. In some cases, the system includes a first image generation model trained, using a teacher image generation model, to generate a proxy guidance (e.g., the intermediate result). The system further includes a second image generation model trained to generate a synthetic image based on an input image, an input mask, and the proxy guidance. The proxy guidance generated by the first image generation model is provided to the second image generation model to ensure that the synthetic image accurately depicts removal of the object indicated by the input mask.

In the field of image editing, particularly in object removal, machine learning systems are used to remove one or more elements from an input image. For example, these systems may identify and segment one or more objects within the input image and then inpaints or fill in the missing pixels in the region where the one or more objects are removed. In some cases, these systems are trained on large image datasets to understand patterns, textures, and contexts. However, in some cases, these systems may generate unrealistic or incorrect pixels in the missing region where the object is removed. In high-resolution object removals, these systems may introduce additional artifacts or impact the image quality of the generated images. In some cases, these systems require a large computational power.

In some cases, when an input is provided to remove an object from an image, conventional systems may generate a different object in place of the object to be removed. For example, when an object mask indicating the object to be removed is provided to the conventional systems, the conventional systems may generate a different object instead of removing the target object indicated by the object mask. As a result, conventional systems are unable to accurately generate a synthetic image that indicates the removal of an object from the input image.

Accordingly, the present disclosure provides a system and method that improve on conventional image generation systems by accurately and efficiently generate a synthetic image that depicts a removal of an image element from an input image. This is achieved using a system that includes a first image generation model trained to generate a proxy guidance, and a second image generation model trained to generate the synthetic image based on the proxy guidance.

According to some aspects, the system receives an input image and an input mask and generates an edited image (e.g., the synthetic image) based on the input image and the input mask. In one aspect, the system includes a first image generation model trained to generate a proxy guidance based on a lower resolution input (e.g., a low-resolution input image and low-resolution input mask). In one aspect, the system includes a teacher image generation model trained to remove an element from the input image. In one aspect, the first image generation model is trained using the distilled knowledge from the teacher image generation model to generate the proxy guidance.

According to some aspects, the proxy guidance is used as input to a second image generation model to guide the image generation process. In one aspect, the second image generation model generates a synthetic image based on the input image, the input mask, and the proxy guidance. In one aspect, one or more elements are removed from the input image and the result is depicted in the synthetic image. In one aspect, the input image and the synthetic image are high-resolution images.

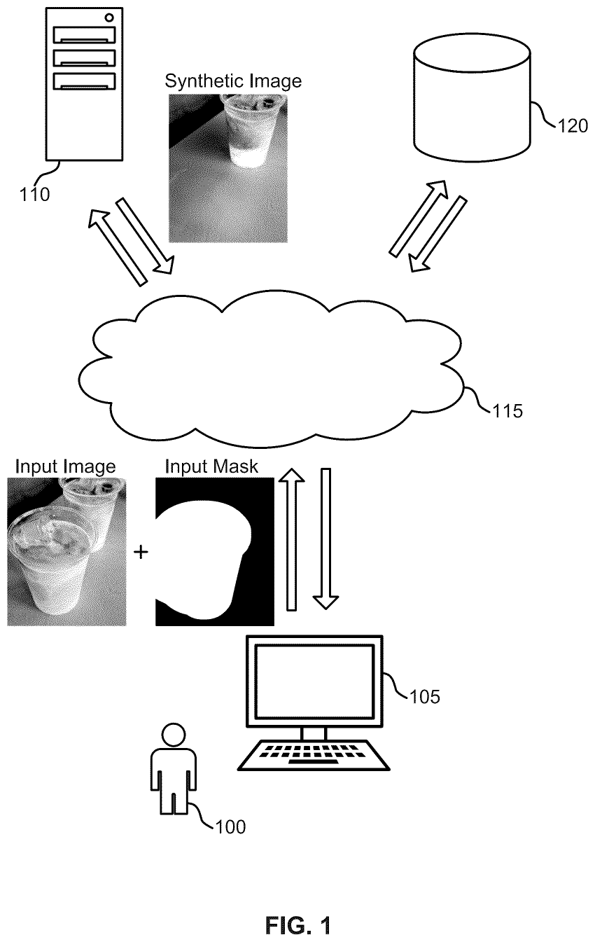

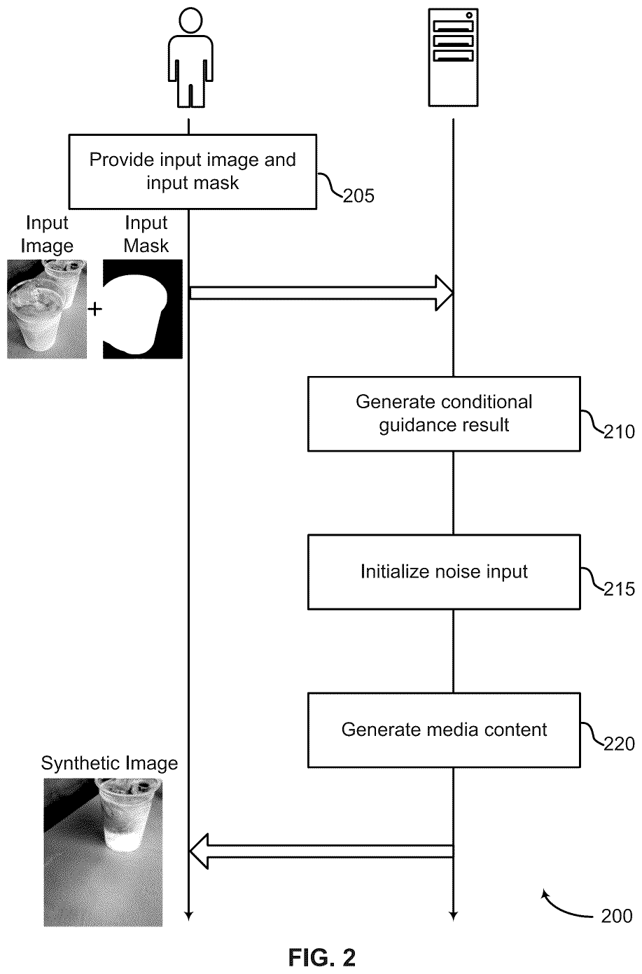

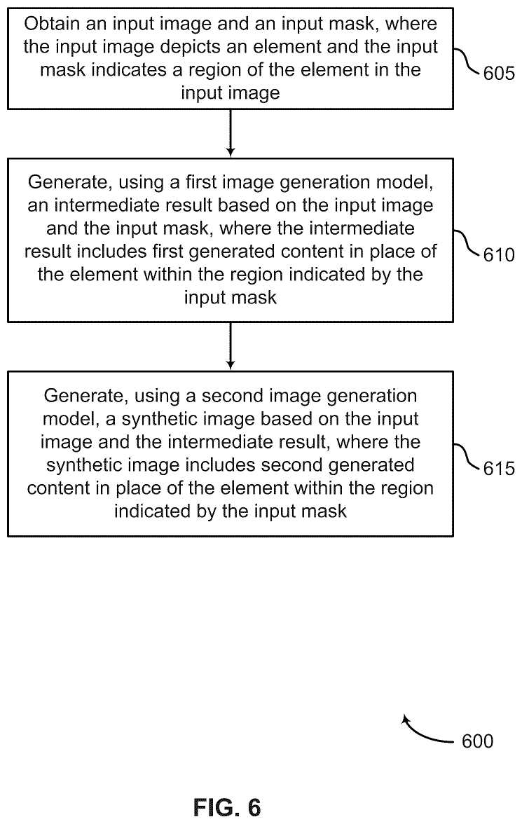

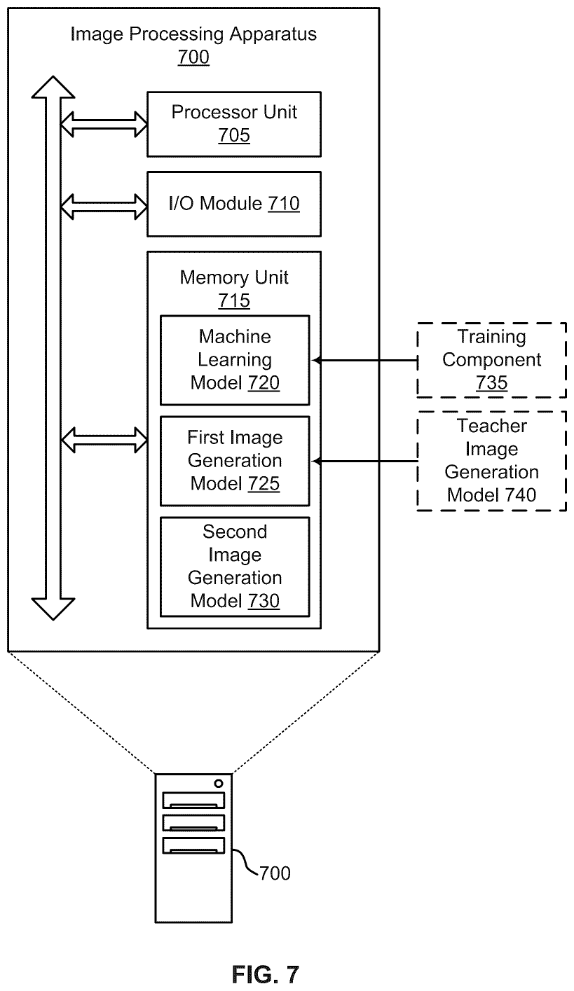

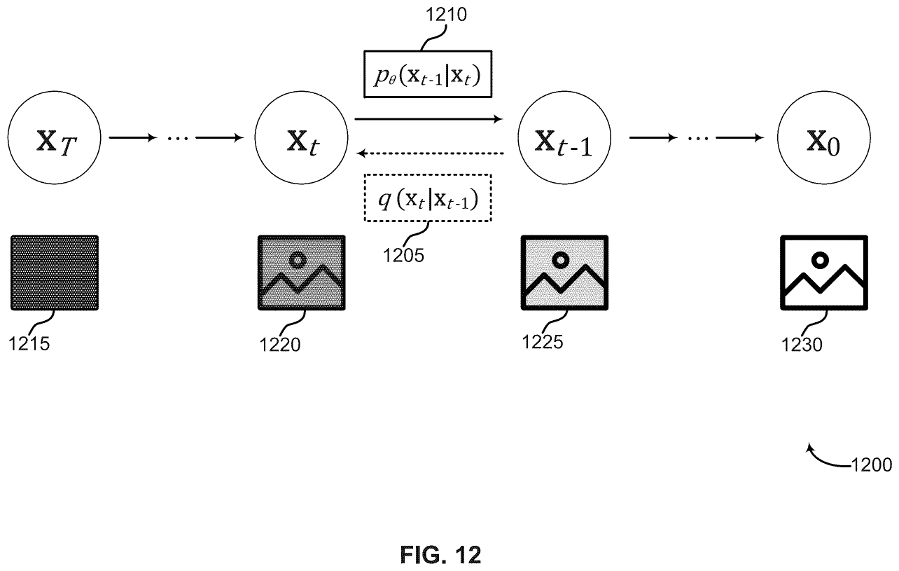

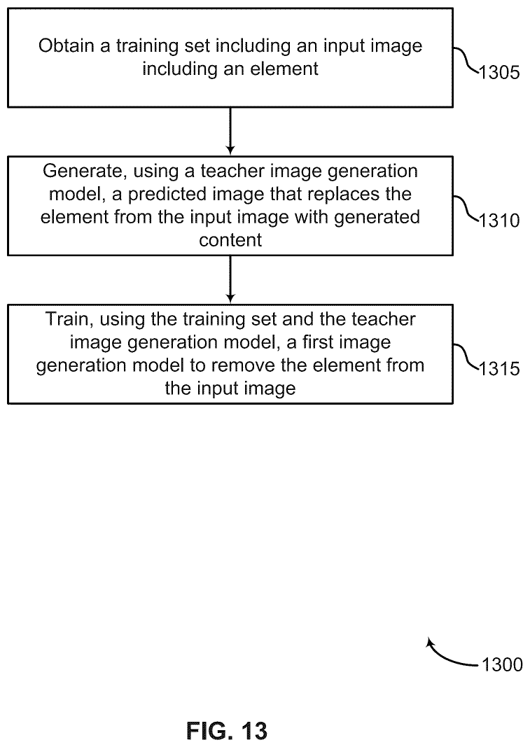

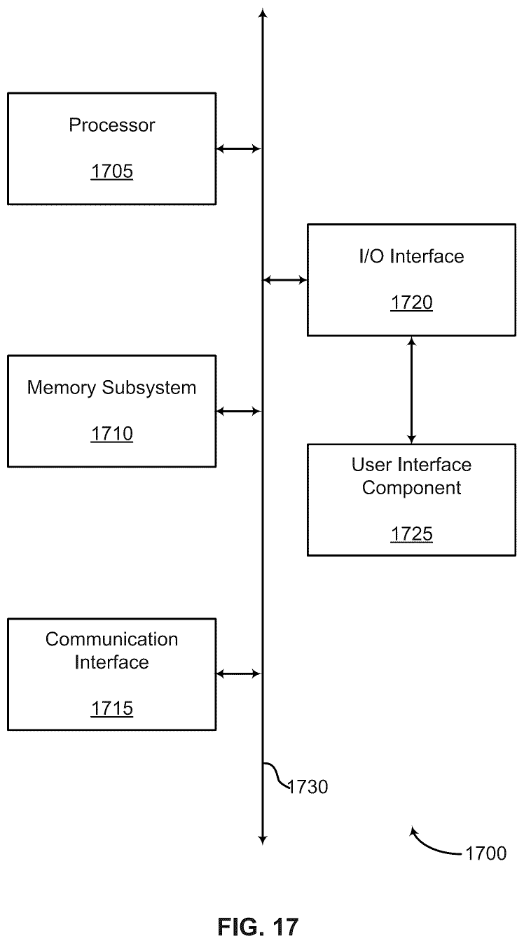

An example system of the inventive concept in image processing is provided with reference to FIGS. 1 and 17. An example application of the inventive concept in image processing is provided with reference to FIGS. 2-5. Details regarding the architecture of an image processing apparatus are provided with reference to FIGS. 7-11. An example of a process for image processing is provided with reference to FIGS. 6 and 12. A description of an example training process is provided with reference to FIGS. 13-16.

Accordingly, embodiments of the disclosure improve on conventional image generation models by generating more accurate synthetic images. For example, embodiments generate images that accurately depict the removal of an element from an input image without unwanted artifacts (e.g., such as replacing an object with an unwanted replacement object). Some embodiments include a first image generation model trained to generate a proxy guidance based on a low-resolution input image. The proxy guidance is provided to a second image generation model to generate the high-resolution synthetic image based on an input image. Accordingly, by using the proxy guidance to guide the diffusion process of the second image generation model, the system is able to accurately generate an image that depicts the removal of the element from the input image.

### Image Editing

In FIGS. 1-6, and 12, a method, apparatus, non-transitory computer readable medium, and system for image processing include obtaining an input image and an input mask, wherein the input image depicts an element and the input mask indicates a region of the element in the input image, generating, using a first image generation model, an intermediate result based on the input image and the input mask, wherein the intermediate result includes first generated content in place of the element within the region indicated by the input mask, and generating, using a second image generation model, a synthetic image based on the input image and the intermediate result, wherein the synthetic image includes second generated content in place of the element within the region indicated by the input mask.

Some embodiments include obtaining an input image and an input mask, wherein the input mask indicates a region of the input image to be modified; generating, using a first image generation model, an intermediate result based on the input image and the input mask, wherein the intermediate result modifies the region of the input image indicated by the input mask; and generating, using a second image generation model, a synthetic image based on the input image and the intermediate result, wherein the synthetic image depicts the input image with content from the modified region at a higher level of detail than the intermediate result. The synthetic image can include content that has a higher resolution or additional textural detail compared to the intermediate result. In some embodiments, the first image generation model is a smaller model than the second image generation model (e.g., it may have fewer layers or fewer parameters), but it is trained specifically for an object removal task.

Some examples of the method, apparatus, non-transitory computer readable medium, and system further include segmenting the input image to identify the region of the element in the input image. Some examples of the method, apparatus, non-transitory computer readable medium, and system further include receiving a location input. Some examples further include generating the input mask based on the location input.

Some examples of the method, apparatus, non-transitory computer readable medium, and system further include receiving a removal prompt, wherein the removal prompt comprises a command to remove the element from the input image. Some examples further include selecting a removal mode based on the removal prompt, wherein the intermediate result is generation based on the removal mode.

In some aspects, the intermediate result comprises an intermediate image having a lower resolution than the synthetic image. In some aspects, the first image generation model has fewer parameters than the second image generation model. In some aspects, the first image generation model is trained to replace the element using a predicted image generated by a teacher image generation model.

Some examples of the method, apparatus, non-transitory computer readable medium, and system further include obtaining a first noise input. Some examples further include denoising the first noise input to obtain the intermediate result. Some examples of the method, apparatus, non-transitory computer readable medium, and system further include obtaining a second noise input. Some examples further include denoising the second noise input to generate the synthetic image.

Some examples of the method, apparatus, non-transitory computer readable medium, and system further include inpainting the region indicated by the input mask with content consistent with the input image. Some examples of the method, apparatus, non-transitory computer readable medium, and system further include generating a plurality of synthetic images including different generated content in place of the element.

According to some aspects, a method, apparatus, non-transitory computer readable medium, and system for image processing include obtaining an input image and an input mask, where the input image depicts an element and the input mask indicates a location of the element in the input image, generating, using a first image generation model, an intermediate result based on the input image and the input mask, where the intermediate result comprises a removal of the element from the input image, and generating, using a second image generation model, a synthetic image based on the intermediate result, where the synthetic image comprises the removal of the element from the input image.

Some examples of the method, apparatus, non-transitory computer readable medium, and system further include segmenting the input image based on the element. Some examples of the method, apparatus, non-transitory computer readable medium, and system further include receiving a location input from a user. Some examples further include generating the input mask based on the location input.

Some examples of the method, apparatus, non-transitory computer readable medium, and system further include receiving a removal prompt from a user. In some cases, the removal prompt comprises a command to remove the element from the input image. Some examples further include selecting a removal mode based on the removal prompt. In some cases, the intermediate result is generation based on the removal mode.

In some aspects, the intermediate result comprises an intermediate image having a lower resolution than the synthetic image. In some aspects, the first image generation model has fewer parameters than the second image generation model. In some aspects, the first image generation model is trained based on an object removal task. Some examples of the method, apparatus, non-transitory computer readable medium, and system further include inpainting a region indicated by the input mask with content consistent with the input image.

Some examples of the method, apparatus, non-transitory computer readable medium, and system further include obtaining a first noise input. Some examples further include performing a first diffusion process on the first noise input. Some examples of the method, apparatus, non-transitory computer readable medium, and system further include obtaining a second noise input. Some examples further include performing a second diffusion process on the second noise input and the intermediate result.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 7.

Referring to FIG. 1, user 100 provides an input image and an input mask to image processing apparatus 110 via user device 105 and cloud 115. For example, the input image depicts two cups of coffee on a table. For example, the input mask indicates a rough region of the first cup of iced coffee on the table. In some cases, user 100 may provide an additional command such as “remove” to image processing apparatus 110 to remove the object indicated by the input mask. Then, a machine learning model of image processing apparatus 110 generates an intermediate image from a student proxy image generation model (e.g., a first image generation model) based on the input image and the input mask. In some cases, for example, the intermediate image is a low-resolution edited image depicting one cup of iced coffee (e.g., the first cup of iced coffee on the bottom left side of the input image is removed). The intermediate image is used as proxy guidance to a second image generation model to generate the synthetic image (in high resolution) based on the input image and the input mask. For example, the synthetic image depicts an edited image of the input image without the cup of coffee indicated by the input mask. Image processing apparatus 110 displays the synthetic image to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

According to some aspects, image processing apparatus 110 includes a computer implemented network comprising a machine learning model, a first image generation model, and a second image generation model. Image processing apparatus 110 further includes a processor unit, a memory unit, an I/O module, a training component, and a teacher image generation model. In some embodiments, image processing apparatus 110 further includes a communication interface, user interface components, and a bus as described with reference to FIG. 17. Additionally or alternatively, image processing apparatus 110 communicates with user device 105 and database 120 via cloud 115. Image processing apparatus 110 is an example of, or includes aspects of, the corresponding element described with reference to FIG. 7. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including an input image that includes an element. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for image editing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides an input image and an input mask. In some cases, the operations of this step refer to, or may be performed by, a user as described with reference to FIG. 1. For example, the input image depicts two cups of iced coffee on a table. For example, the input mask depicts the region of the element to be removed from the input image. In some cases, for example, a command may be provided to the system in addition to the input image and the input mask. For example, the command may be “remove”.

At operation 210, the system generates a conditional guidance result. In some cases, the operations of this step refer to, or may be performed by, an image processing apparatus as described with reference to FIGS. 1 and 7. In some cases, the operations of this step refer to, or may be performed by, a first image generation model as described with reference to FIGS. 7-9, and 14. In some cases, the system generates a low-resolution proxy result based on the input image and the input mask. In some cases, the conditional guidance result includes the low-resolution proxy result generated by the first image generation model. The low-resolution proxy result is used as guidance to guide the image generation process of the second image generation model to generate the synthetic image.

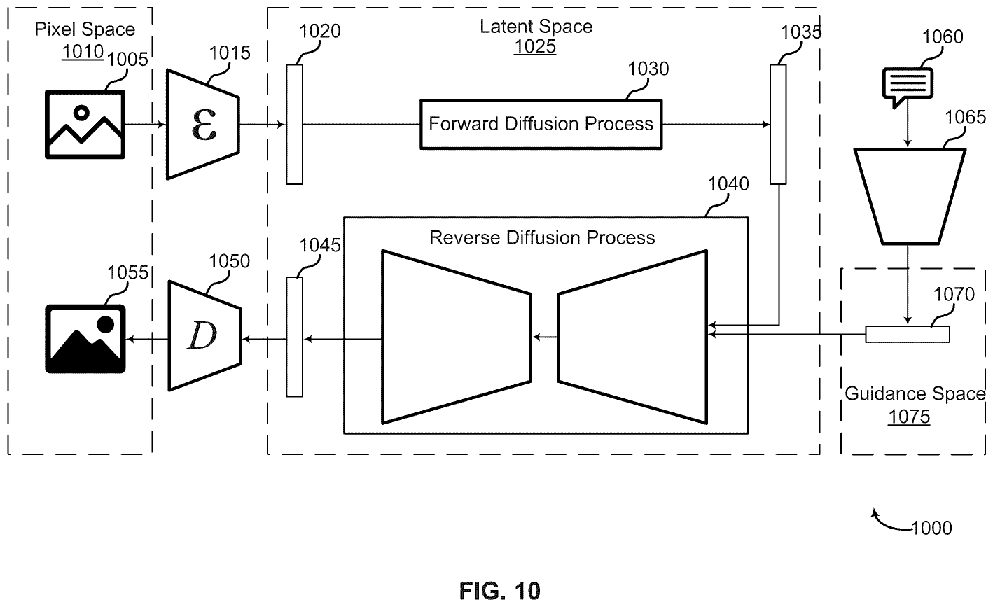

At operation 215, the system initializes noise input. In some cases, the operations of this step refer to, or may be performed by, an image processing apparatus as described with reference to FIGS. 1 and 7. In some cases, the operations of this step refer to, or may be performed by, a second image generation model as described with reference to FIGS. 7-9, and 14. In some cases, the noise input including random noise is initialized. The noise input may be in a latent space. By initializing the image generation model with random noise, different variations of a synthetic image can be generated. In some cases, a condition embedding such as a text encoding or a text embedding may be combined with a noisy feature using a cross-attention block within the image generation model to guide the image generation process. Further detail on the image generation process is described with reference to FIG. 10.

At operation 220, the system generates media content. In some cases, the operations of this step refer to, or may be performed by, an image processing apparatus as described with reference to FIGS. 1 and 7. In some cases, the operations of this step refer to, or may be performed by, a second image generation model as described with reference to FIGS. 7-9, and 14. In some cases, for example, the media content includes a synthetic image or a modified image each depicting a removal of a cup of iced coffee from the input image. For example, the synthetic image includes image pixels generated by the image generation model. For example, a modified image includes image pixels from the input image and image pixels generated by the image generation model. In some cases, the media content is displayed to the user via a user device.

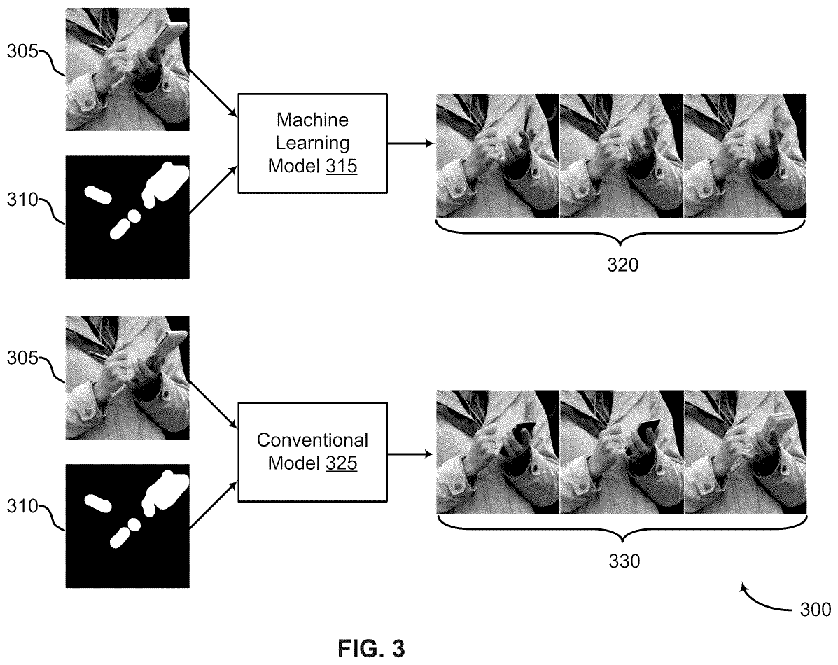

FIG. 3 shows an example of object removal using proxy guidance according to aspects of the present disclosure. The example shown includes image editing system 300, input image 305, input mask 310, machine learning model 315, synthetic images 320, conventional model 325, and conventional synthetic images 330.

Referring to FIG. 3, machine learning model 315 receives input image 305 and input mask 310 to generate synthetic images 320. For example, input image 305 depicts a person holding a writing pad and a pen. For example, input mask 310 indicates a region (or regions) representing the object to be removed (e.g., the writing pad and the pen). In some cases, a user may provide a rough sketch indicating the location of the object to be removed. Then, machine learning model 315 may generate a precise mask based on the rough sketch. For example, the machine learning model may segment input image 305 to obtain a plurality of segmented objects, and each of the plurality of segmented objects represents an object in the input image 305.

In some embodiments, machine learning model 315 generates an intermediate result based on the input image 305 and input mask 310. For example, the intermediate result is a low-resolution image depicting the input image 305 without the element indicated by the input mask 310. In some cases, the intermediate result is used as guidance to guide the image generation process of an image generation model of the machine learning model 315 to generate synthetic images 320. For example, synthetic images 320 are high-resolution images depicting the input image 305 without the element indicated by input mask 310.

In contrast to the synthetic images, conventional synthetic images 330 generated by the conventional model 325 depicts a replacement of objects indicated by input mask 310 instead of a removal of the object. For example, the left image of conventional synthetic images 330 depicts the removal of the pen and the replacement of the writing pad with a phone. For example, the middle image of conventional synthetic images 330 depicts the removal of a pen and the replacement of the writing pad with a different writing pad. For example, the right image of conventional synthetic images 330 depicts the removal of the pen and the replacement of the writing pad with a stack of napkins.

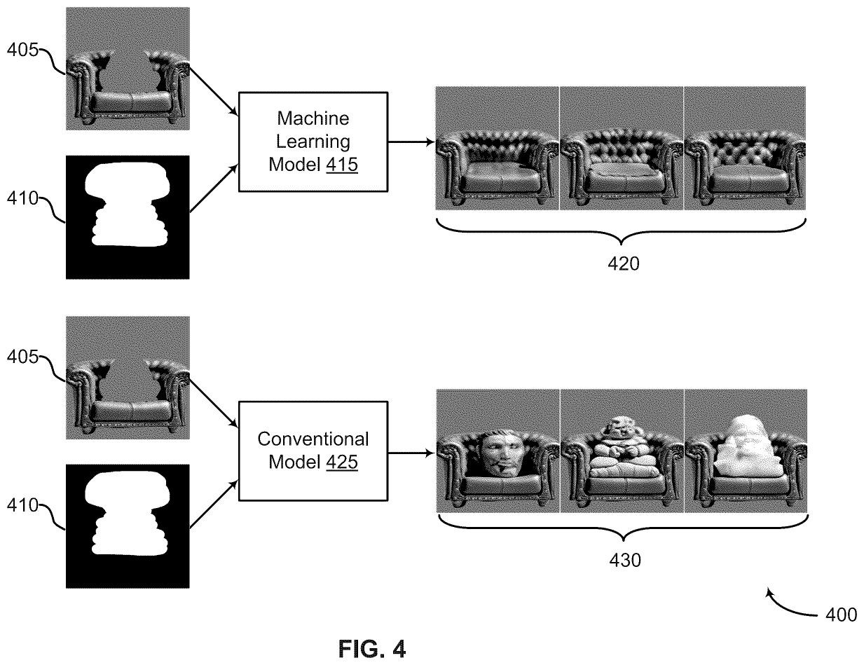

Image editing system 300 is an example of, or includes aspects of, the corresponding element described with reference to FIGS. 4, 5, and 9. Input image 305 is an example of, or includes aspects of, the corresponding element described with reference to FIGS. 4, 5, 8, 9, and 14. Input mask 310 is an example of, or includes aspects of, the corresponding element described with reference to FIGS. 4, 5, 8, and 9.

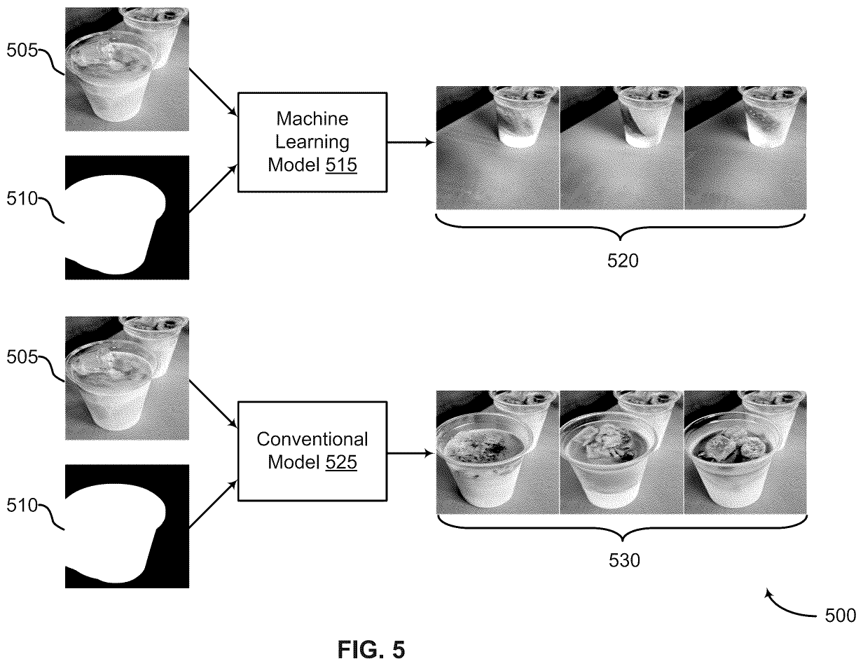

Machine learning model 315 is an example of, or includes aspects of, the corresponding element described with reference to FIGS. 4, 5, and 7. Synthetic images 320 is an example of, or includes aspects of, the corresponding element described with reference to FIGS. 4, 5, and 8. Conventional model 325 is an example of, or includes aspects of, the corresponding element described with reference to FIGS. 4 and 5. Conventional synthetic images 330 is an example of, or includes aspects of, the corresponding element described with reference to FIGS. 4 and 5.

FIG. 4 shows an example of object removal using proxy guidance according to aspects of the present disclosure. The example shown includes image editing system 400, input image 405, input mask 410, machine learning model 415, synthetic images 420, conventional model 425, and conventional synthetic images 430.

Referring to FIG. 4, machine learning model 415 receives input image 405 and input mask 410 to generate synthetic images 420. For example, input image 405 depicts a statute on a couch. For example, input mask 410 indicates a region representing the object to be removed (e.g., the statute). In some cases, a user may provide a rough sketch indicating location of the object to be removed. Then, machine learning model 415 may generate a precise mask representing the object based on the rough sketch. For example, the machine learning model may segment input image 405 to obtain a plurality of segmented objects, and each of the plurality of segmented objects represents an object in the input image 405.

In some embodiments, machine learning model 415 generates an intermediate result based on the input image 405 and input mask 410. For example, the intermediate result is a low-resolution image depicting the input image 405 without the element indicated by the input mask 410. In some cases, the intermediate result is used as guidance to guide the image generation process of an image generation model of the machine learning model 415 to generate synthetic images 420. For example, synthetic images 420 are high-resolution images depicting the input image 405 without the element indicated by input mask 410. In contrast, conventional model 425 generates conventional synthetic images 430 having replaced objects instead of removed objects indicated by input mask 410.

Image editing system 400 is an example of, or includes aspects of, the corresponding element described with reference to FIGS. 3, 5, and 9. Input image 405 is an example of, or includes aspects of, the corresponding element described with reference to FIGS. 3, 5, 8, 9, and 14. Input mask 410 is an example of, or includes aspects of, the corresponding element described with reference to FIGS. 3, 5, 8, and 9.

Machine learning model 415 is an example of, or includes aspects of, the corresponding element described with reference to FIGS. 3, 5, and 7. Synthetic images 420 is an example of, or includes aspects of, the corresponding element described with reference to FIGS. 3, 5, and 8. Conventional model 425 is an example of, or includes aspects of, the corresponding element described with reference to FIGS. 3 and 5. Conventional synthetic images 430 is an example of, or includes aspects of, the corresponding element described with reference to FIGS. 3 and 5.

FIG. 5 shows an example of object removal using proxy guidance according to aspects of the present disclosure. The example shown includes image editing system 500, input image 505, input mask 510, machine learning model 515, synthetic images 520, conventional model 525, and conventional synthetic images 530.

Referring to FIG. 5, machine learning model 515 receives input image 505 and input mask 510 to generate synthetic images 520. For example, input image 505 depicts two cups of coffee on a table. For example, input mask 510 indicates a region representing the object to be removed (e.g., the first cup of coffee in the front). In some cases, a user may provide a rough sketch indicating the location of the object to be removed. Then, machine learning model 515 may generate a precise mask representing the object based on the rough sketch. For example, the machine learning model 515 may segment input image 505 to obtain a plurality of segmented objects, and each of the plurality of segmented objects represents an object in the input image 505.

In some embodiments, machine learning model 515 generates an intermediate result based on the input image 505 and input mask 510. For example, the intermediate result is a low-resolution image depicting the input image 505 without the element indicated by the input mask 510. In some cases, the intermediate result is used as guidance to guide the image generation process of an image generation model of the machine learning model 515 to generate synthetic images 520. For example, synthetic images 520 are high-resolution images depicting the input image 505 without the element indicated by input mask 510. In contrast, conventional model 525 generates conventional synthetic images 530 having replaced objects instead of removed objects indicated by input mask 510.

Image editing system 500 is an example of, or includes aspects of, the corresponding element described with reference to FIGS. 3, 4, and 9. Input image 505 is an example of, or includes aspects of, the corresponding element described with reference to FIGS. 3, 4, 8, 9, and 14. Input mask 510 is an example of, or includes aspects of, the corresponding element described with reference to FIGS. 3, 4, 8, and 9.

Machine learning model 515 is an example of, or includes aspects of, the corresponding element described with reference to FIGS. 3, 4, and 7. Synthetic images 520 is an example of, or includes aspects of, the corresponding element described with reference to FIGS. 3, 4, and 8. Conventional model 525 is an example of, or includes aspects of, the corresponding element described with reference to FIGS. 3 and 4. Conventional synthetic images 530 is an example of, or includes aspects of, the corresponding element described with reference to FIGS. 3 and 4.

FIG. 6 shows an example of a method 600 for image editing based on a proxy guidance according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains an input image and an input mask, where the input image depicts an element and the input mask indicates a region of the element in the input image. In some cases, the operations of this step refer to, or may be performed by, a machine learning model as described with reference to FIGS. 3-5, and 7. In some cases, the element may be substantially the same as an image element. For example, an image element is an image component or image feature that makes up the overall composition of an image (e.g., the input image), such as an object, entity, subject, shape, color, texture, pattern, background scene, visual attributes, and/or style. For example, the image element may be an animal such as a cat or dog, a person, an object such as a hat or table, a scene such as a beach or mountain top, or a combination thereof. For example, the image element or element may be the cup of iced coffee depicted in FIG. 5.

At operation 610, the system generates, using a first image generation model, an intermediate result based on the input image and the input mask, where the intermediate result includes first generated content in place of the element within the region indicated by the input mask. In some cases, the operations of this step refer to, or may be performed by, a first image generation model as described with reference to FIGS. 7-9, and 14. In some cases, the first image generation model is a student proxy model trained to generate a low-resolution output based on a low-resolution input. In some cases, a teacher image generation model (or a proxy teacher model) distillates knowledge from the teacher image generation model to the student proxy model. For example, the student proxy model is a smaller, simpler, and faster model than the teacher proxy model. In some cases, for example, the teacher proxy model is a high-capacity model trained on a large dataset. By distillate the knowledge from the teacher proxy model to the student proxy model, the student proxy model is able to accurately generate a low-resolution output while reducing the computational cost. In some cases, the intermediate result includes the low-resolution output. In some cases, the intermediate result is used as guidance to a second image generation model to guide the image generation process.

At operation 615, the system generates, using a second image generation model, a synthetic image based on the input image and the intermediate result, where the synthetic image includes second generated content in place of the element within the region indicated by the input mask. In some cases, the operations of this step refer to, or may be performed by, a second image generation model as described with reference to FIGS. 7-9, and 14. In some cases, the second image generation model is conditioned based on a reference image (e.g., the intermediate result) to generate the synthetic image. For example, the intermediate result is a low-resolution image depicting the input image without the object indicated by the input mask. The second image generation model is guided based on the low-resolution image to generate the synthetic image. In some cases, the second image generation model is a larger model compared to the first image generation model. For example, the second image generation model may receive a high-resolution input image and generate a high-resolution synthetic image.

In some cases, the second image generation model may generate a synthetic image or a modified image. For example, the synthetic image includes image pixels generated by the image generation model. For example, the modified image includes image pixels from the input image and image pixels generated by the image generation model.

### System Architecture

In FIGS. 7-11 and 17, an apparatus and system for image processing include a memory component and a processing device coupled to the memory component, the processing device configured to perform operations comprising: obtaining an input image and an input mask, wherein the input image depicts an element and the input mask indicates a region of the element in the input image, generating, using a first image generation model, an intermediate result based on the input image and the input mask, wherein the intermediate result includes first generated content in place of the element within the region indicated by the input mask, and generating, using a second image generation model, a synthetic image based on the input image and the intermediate result, wherein the synthetic image includes second generated content in place of the element within the region indicated by the input mask.

Some examples of the apparatus and system further include a teacher image generation model, wherein the teacher image generation model is trained to remove the element from the input image. In some aspects, the first image generation model and the second image generation model are diffusion models. In some aspects, the first image generation model has fewer parameters than the second image generation model.

FIG. 7 shows an example of an image processing apparatus 700 according to aspects of the present disclosure. The example shown includes image processing apparatus 700, processor unit 705, I/O module 710, memory unit 715, training component 735, and teacher image generation model 740. In one aspect, memory unit 715 includes machine learning model 720, first image generation model 725, and second image generation model 730.

According to some embodiments of the present disclosure, image processing apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 17.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 710 is an example of, or includes aspects of, the I/O interface described with reference to FIG. 17.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein.

In some cases, memory unit 715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state.

In one aspect, memory unit 715 includes machine learning model 720, first image generation model 725, and second image generation model 730. In some aspect, the machine learning model 720 includes first image generation model 725 and second image generation model 730. Memory unit 715 is an example of, or includes aspects of, the memory subsystem described with reference to FIG. 17.

In some cases, machine learning model 720 is a computational algorithm, model, or system designed to recognize patterns, make predictions, or perform a specific task (for example, image processing) without being explicitly programmed. According to some aspects, machine learning model 720 is implemented as software stored in memory unit 715 and executable by processor unit 705, as firmware, as one or more hardware circuits, or as a combination thereof.

According to some embodiments of the present disclosure, machine learning model 720 includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model 720 includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model 720 includes machine learning parameters. Machine learning parameters, also known as model parameters or weights, are variables that provide behavior and characteristics of machine learning model 720. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow machine learning model 720 to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model 720 includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model 720 includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model 720 in which representations of the input interact with each other to determine attention weights for the input. Self-attention can be distinguished from other attention models because the attention weights are determined at least in part by the input itself.

According to some aspects, machine learning model 720 obtains an input image and an input mask, where the input image depicts an element and the input mask indicates a region of the element in the input image. In some examples, machine learning model 720 segments the input image to identify the region of the element in the input image. In some examples, machine learning model 720 receives a location input. In some examples, machine learning model 720 generates the input mask based on the location input.

In some examples, machine learning model 720 receives a removal prompt, where the removal prompt includes a command to remove the element from the input image. In some examples, machine learning model 720 selects a removal mode based on the removal prompt, where the intermediate result is generation based on the removal mode. Machine learning model 720 is an example of, or includes aspects of, the corresponding element described with reference to FIGS. 3-5.

According to some aspects, first image generation model 725 is implemented as software stored in memory unit 715 and executable by processor unit 705, as firmware, as one or more hardware circuits, or as a combination thereof. According to some aspects, first image generation model 725 generates an intermediate result based on the input image and the input mask, where the intermediate result includes first generated content in place of the element within the region indicated by the input mask. In some aspects, the intermediate result includes an intermediate image having a lower resolution than the synthetic image. In some aspects, the first image generation model 725 has fewer parameters than the second image generation model 730.

In some examples, first image generation model 725 obtains a first noise input. In some examples, first image generation model 725 denoises the first noise input to obtain the intermediate result. In some aspects, the first image generation model 725 is trained to replace the element using a predicted image generated by a teacher image generation model 740. In some aspects, the first image generation model 725 has fewer parameters than the teacher image generation model 740.

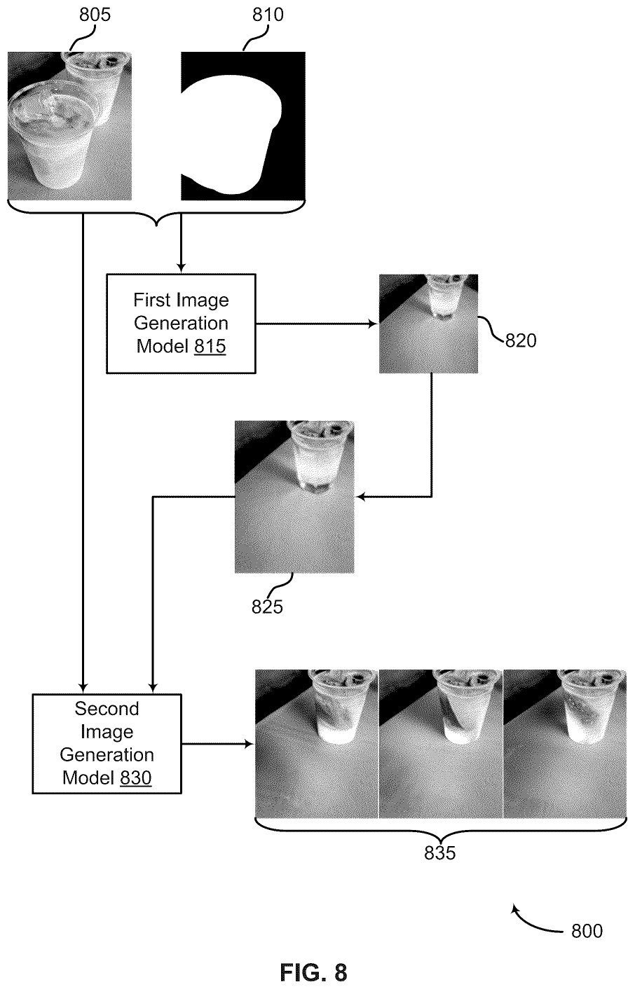

According to some aspects, first image generation model 725 generates an intermediate result based on the input image and the input mask, wherein the intermediate result includes first generated content in place of the element within the region indicated by the input mask. In some aspects, the first image generation model 725 and the second image generation model 730 are diffusion models. In some aspects, the first image generation model 725 has fewer parameters than the second image generation model 730. First image generation model 725 is an example of, or includes aspects of, the corresponding element described with reference to FIGS. 8, 9, and 14.

According to some aspects, second image generation model 730 is implemented as software stored in memory unit 715 and executable by processor unit 705, as firmware, as one or more hardware circuits, or as a combination thereof. According to some aspects, second image generation model 730 generates a synthetic image based on the input image and the intermediate result, where the synthetic image includes second generated content in place of the element within the region indicated by the input mask. In some examples, second image generation model 730 obtains a second noise input. In some examples, second image generation model 730 denoises the second noise input to generate the synthetic image.

In some examples, second image generation model 730 inpaints the region indicated by the input mask with content consistent with the input image. In some examples, second image generation model 730 generates a set of synthetic images including different generated content in place of the element. According to some aspects, second image generation model 730 generates a synthetic image based on the input image and the intermediate result, wherein the synthetic image includes second generated content in place of the element within the region indicated by the input mask. Second image generation model 730 is an example of, or includes aspects of, the corresponding element described with reference to FIGS. 8, 9, and 14.

According to some aspects, training component 735 is implemented as software stored in memory unit 715 and executable by processor unit 705, as firmware, as one or more hardware circuits, or as a combination thereof. According to some embodiments, training component 735 is implemented as software stored in a memory unit and executable by a processor in the processor unit of a separate computing device, as firmware in the separate computing device, as one or more hardware circuits of the separate computing device, or as a combination thereof. In some examples, training component 735 is part of another apparatus other than image processing apparatus 700 and communicates with the image processing apparatus 700. In some examples, training component 735 is part of image processing apparatus 700.

According to some aspects, training component 735 obtains a training set including an input image including an element. In some examples, training component 735 trains, using the training set and the predicted image, a first image generation model 725 to replace the element from the input image with the generated content. In some examples, training component 735 trains the teacher image generation model 740 to replace the element from the input image. In some examples, training component 735 computes a diffusion loss. In some examples, training component 735 updates parameters of the first image generation model 725 based on the diffusion loss. In some examples, training component 735 trains a second image generation model 730 to replace the element from the input image based on an output of the first image generation model 725.

According to some aspects, training component 735 obtains a training set including an input image including an element. In some examples, training component 735 obtains a teacher image generation model 740, where the teacher image generation model 740 is trained to remove the element from the input image. In some examples, training component 735 trains, using the training set and the teacher image generation model 740, a first image generation model 725 to remove the element from the input image. In some examples, training component 735 trains the teacher image generation model 740 to remove the element from the input image.

In some examples, training component 735 obtains a ground-truth image including a removal of the element from the input image, where the teacher image generation model 740 is trained based on the ground-truth image. In some examples, training component 735 computes a diffusion loss. In some examples, training component 735 updates parameters of the first image generation model 725 based on the diffusion loss. In some examples, training component 735 trains a second image generation model 730 to remove the element from the input image based on an output of the first image generation model 725.

According to some aspects, teacher image generation model 740 is implemented as software stored in memory unit 715 and executable by processor unit 705, as firmware, as one or more hardware circuits, or as a combination thereof. According to some embodiments, teacher image generation model 740 is implemented as software stored in a memory unit and executable by a processor in the processor unit of a separate computing device, as firmware in the separate computing device, as one or more hardware circuits of the separate computing device, or as a combination thereof. In some examples, teacher image generation model 740 is part of another apparatus other than image processing apparatus 700 and communicates with the image processing apparatus 700. In some examples, teacher image generation model 740 is part of image processing apparatus 700.

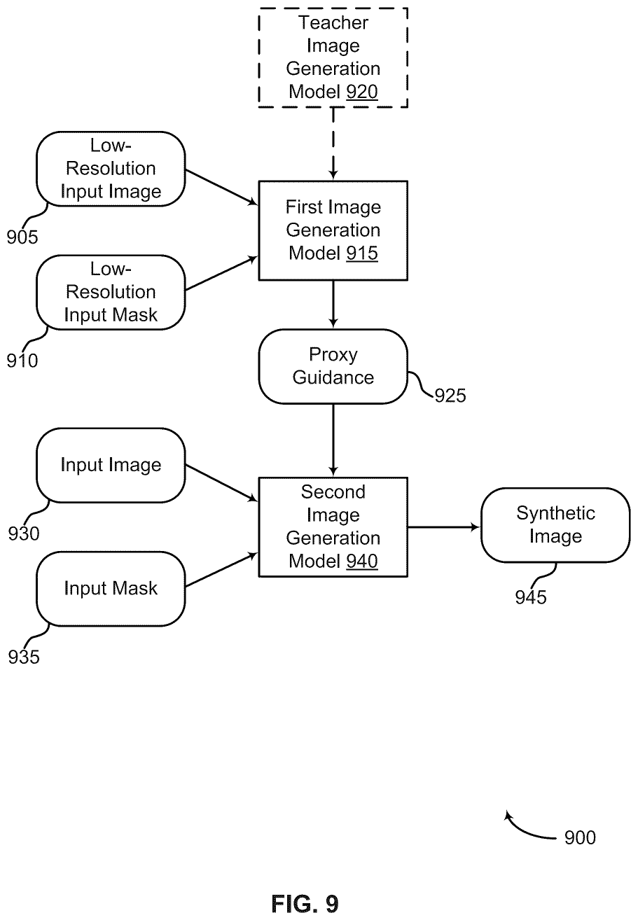

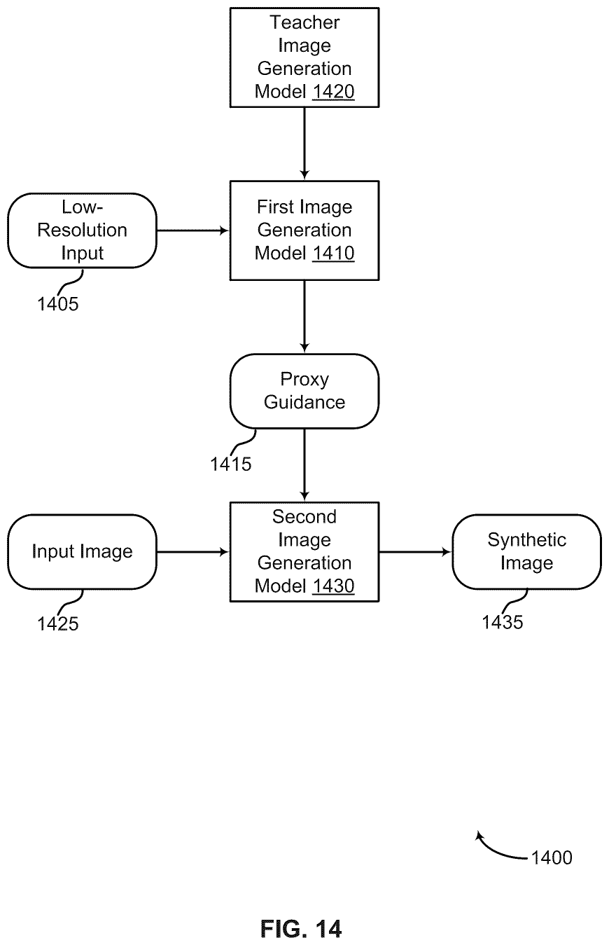

According to some aspects, teacher image generation model 740 generates a predicted image that replaces the element from the input image with generated content. According to some aspects, teacher image generation model 740 is trained to remove the element from the input image. Teacher image generation model 740 is an example of, or includes aspects of, the corresponding element described with reference to FIGS. 9 and 14.

FIG. 8 shows an example of a machine learning model according to aspects of the present disclosure. The example shown includes machine learning system 800, input image 805, input mask 810, first image generation model 815, proxy result 820, proxy guidance 825, second image generation model 830, and synthetic images 835.

Referring to FIG. 8, machine learning system 800 receives input image 805 and input mask 810 to generate synthetic images 835. For example, first image generation model 815 receives input image 805 and input mask 810 to generate proxy result 820. In one aspect, first image generation model 815 is a student proxy diffusion model trained to generate a low-resolution output image based on a low-resolution input image. In some embodiments, the first image generation model 815 is trained on object removal tasks. For example, object removal tasks involve identifying and removing an object from a region of the image while seamlessly reconstructing the missing image pixels of the removed object to maintain a natural look. In some cases, this process uses inpainting techniques to fill in the removed region or image pixels, often guided by context, texture, and image elements from surrounding regions of the image.

For example, a teacher proxy image generation model distillates knowledge from the teacher proxy image generation model (or a teacher image generation model) to a student image generation (e.g., first image generation model 815) during training. In one aspect, the teacher proxy image generation model is a complex, high-capacity image generation model trained on a large dataset. The teacher proxy image generation model is trained to remove objects/elements from an input image (e.g., input image 805) to generate an edited image without the element. When the distillation process is performed, the knowledge from the teacher proxy image generation model is transferred to the student proxy model (or first image generation model 815), so that the first image generation model 815 is able to perform the same function as the teacher proxy image generation model in low capacity manner. In some cases, for example, the teacher proxy image generation model distillates from 40 steps to 5 steps. In one aspect, first image generation model 815 is a smaller, simpler, and faster model compared to the teacher proxy image generation model. In one aspect, first image generation model 815 has fewer parameters and uses fewer computational resources. Accordingly, first image generation model 815 is able to generate a low-resolution output image faster and more accurately.

In some embodiments, second image generation model 830 receives input image 805, input mask 810, and proxy guidance 825 to generate one or more synthetic images 835. In some cases, second image generation model 830 is a high-capacity (or high-resolution) diffusion model. For example, second image generation model 830 has more parameters than first image generation model 815. In some embodiments, first image generation model 815 has the same number of parameters as second image generation model 830. For example, proxy result 820 is used as proxy guidance 825 to second image generation model 830. In some embodiments, second image generation model 830 is trained to generate synthetic images 835 conditioned on reference images (e.g., proxy result 820 or proxy guidance 825). For example, proxy guidance 825 is used as guidance to guide the diffusion process in second image generation model 830. In some cases, synthetic images 835 depict various versions of input image 805 without the object indicated by the input mask 810. In some cases, synthetic images 835 are high-quality images.

In some embodiments, the second image generation model 830 is trained for mixed tasks for image editing and image generation. For example, the second image generation model 830 may be trained on tasks such as inpainting, super-resolution, object removal, style transfer, and image-to-image translation. In some cases, the second image generation model 830 is able to perform various image editing operations efficiently, while reducing the need for a separate model for each of the specific task.

Input image 805 is an example of, or includes aspects of, the corresponding element described with reference to FIGS. 3-5, 9, and 14. Input mask 810 is an example of, or includes aspects of, the corresponding element described with reference to FIGS. 3-5, and 9. First image generation model 815 is an example of, or includes aspects of, the corresponding element described with reference to FIGS. 7, 9, and 14.

Proxy guidance 825 is an example of, or includes aspects of, the corresponding element described with reference to FIGS. 9 and 14. Second image generation model 830 is an example of, or includes aspects of, the corresponding element described with reference to FIGS. 7, 9, and 14. Synthetic images 835 is an example of, or includes aspects of, the corresponding element described with reference to FIGS. 3-5.

FIG. 9 shows an example of an object removal system according to aspects of the present disclosure. The example shown includes image editing system 900, low-resolution input image 905, low-resolution input mask 910, first image generation model 915, teacher image generation model 920, proxy guidance 925, input image 930, input mask 935, second image generation model 940, and synthetic image 945.

Referring to FIG. 9, first image generation model 915 receives low-resolution input image 905 and low-resolution input mask 910 to generate proxy guidance 925. In some cases, teacher image generation model 920 performs distillation which transfers knowledge to first image generation model 915 during training time. In some cases, first image generation model 915 is a low-capacity diffusion model that can generate an output (e.g., proxy guidance 925) faster. By performing knowledge distillation, the knowledge from the teacher image generation model 920 is transferred to first image generation model 915, so that the first image generation model 915 is able to perform the same function of the teacher image generation model 920 in a low-capacity manner. In some cases, teacher image generation model 920 is a larger model and has more parameters than first image generation model 915.

In some embodiments, second image generation model 940 receives input image 930 and input mask 935 to generate synthetic image 945. For example, input image 930 is a high-resolution image. In some aspects, for example, second image generation model 940 is a high-capacity diffusion model, where the second image generation model 940 has more parameters than first image generation model 915. In some cases, synthetic image 945 is a high-resolution image. In some embodiments, second image generation model 940 receives proxy guidance 925 as guidance to guide the image generation process (e.g., the diffusion process). For example, the proxy guidance 925 is an image depicting input image 930 (or low-resolution input image 905) without the object indicated by input mask 935 (or low-resolution input mask 910). When using proxy guidance 925 to guide the image generation process, image features closely representing the proxy guidance 925 are input into second image generation model 940. Accordingly, synthetic image 945 includes features of the proxy guidance 925.

In some embodiments, second image generation model 940 performs inpainting on a region of input image 930 indicated by input mask 935. For example, second image generation model 940 generates additional pixels having content consistent with input image 930. In some cases, second image generation model 940 identifies a region of the image (e.g., input image 930) to be inpainted. In one aspect, the region is indicated by input mask 935. Then, second image generation model 940 inpaints the region using pixel information from nearby pixels of input image 930. In some cases, second image generation model 940 uses texture synthesis to perform the inpainting. In some cases, second image generation model 940 may perform blending between the synthetically generated pixels in the inpainted region and the remaining region of the input image 930. In some cases, the inpainted image (or synthetic image 945) is refined or filtered.

Image editing system 900 is an example of, or includes aspects of, the corresponding element described with reference to FIGS. 3-5. First image generation model 915 is an example of, or includes aspects of, the corresponding element described with reference to FIGS. 7, 8, and 14. Teacher image generation model 920 is an example of, or includes aspects of, the corresponding element described with reference to FIGS. 7 and 14. Proxy guidance 925 is an example of, or includes aspects of, the corresponding element described with reference to FIGS. 8 and 14.

Input image 930 is an example of, or includes aspects of, the corresponding element described with reference to FIGS. 3-5, 8, and 14. Input mask 935 is an example of, or includes aspects of, the corresponding element described with reference to FIGS. 3-5, and 8. Second image generation model 940 is an example of, or includes aspects of, the corresponding element described with reference to FIGS. 7, 8, and 14. Synthetic image 945 is an example of, or includes aspects of, the corresponding element described with reference to FIG. 14.

FIG. 10 shows an example of an image generation model according to aspects of the present disclosure. The example shown includes diffusion model 1000, original image 1005, pixel space 1010, image encoder 1015, original image feature 1020, latent space 1025, forward diffusion process 1030, noisy feature 1035, reverse diffusion process 1040, denoised image feature 1045, image decoder 1050, output image 1055, text prompt 1060, text encoder 1065, guidance feature 1070, and guidance space 1075.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image, or to image features generated by an encoder (e.g., latent diffusion).

Diffusion models work by iteratively adding noise to the data during a forward process and then learning to recover the data by denoising the data during a reverse process. For example, during training, diffusion model 1000 may take an original image 1005 in a pixel space 1010 as input and apply an image encoder 1015 to convert original image 1005 into original image feature 1020 in a latent space 1025. Then, a forward diffusion process 1030 gradually adds noise to the original image feature 1020 to obtain noisy feature 1035 (also in latent space 1025) at various noise levels.

Next, a reverse diffusion process 1040 (e.g., a U-Net ANN) gradually removes the noise from the noisy feature 1035 at the various noise levels to obtain the denoised image feature 1045 in latent space 1025. In some examples, denoised image feature 1045 is compared to the original image feature 1020 at each of the various noise levels, and parameters of the reverse diffusion process 1040 of the diffusion model are updated based on the comparison. Finally, an image decoder 1050 decodes the denoised image feature 1045 to obtain an output image 1055 in pixel space 1010. In some cases, an output image 1055 is created at each of the various noise levels. The output image 1055 can be compared to the original image 1005 to train the reverse diffusion process 1040. In some cases, output image 1055 refers to the synthetic image (e.g., described with reference to FIGS. 3-5 and 8-9).

In some cases, image encoder 1015 and image decoder 1050 are pre-trained prior to training the reverse diffusion process 1040. In some examples, image encoder 1015 and image decoder 1050 are trained jointly, or the image encoder 1015 and image decoder 1050 are fine-tuned jointly with the reverse diffusion process 1040.

The reverse diffusion process 1040 can also be guided based on a text prompt 1060, or another guidance prompt, such as an image, a layout, a style, a color, a segmentation map, etc. The text prompt 1060 can be encoded using a text encoder 1065 (e.g., a multimodal encoder) to obtain guidance feature 1070 in guidance space 1075. The guidance feature 1070 can be combined with the noisy feature 1035 at one or more layers of the reverse diffusion process 1040 to ensure that the output image 1055 includes content described by the text prompt 1060. For example, guidance feature 1070 can be combined with the noisy feature 1035 using a cross-attention block within the reverse diffusion process 1040.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, enabling the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

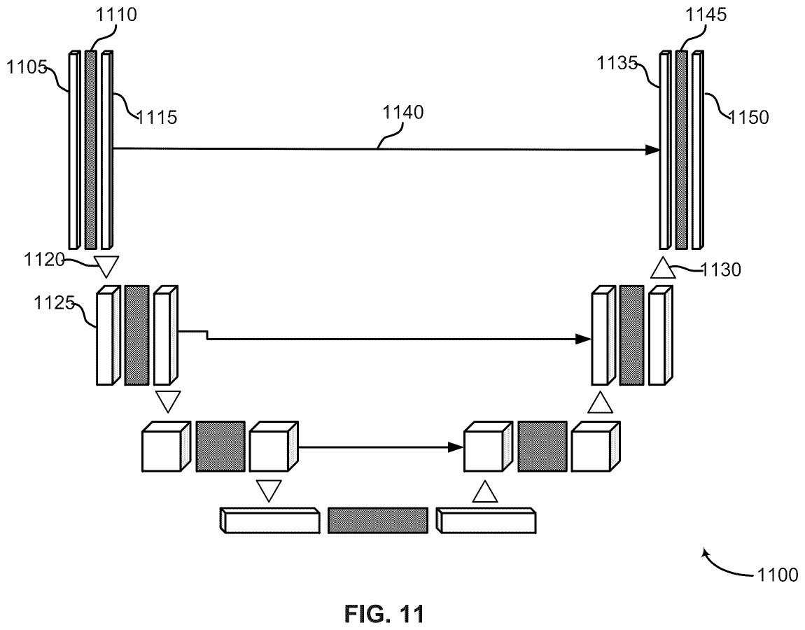

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIG. 11.

A diffusion process may also be modified based on conditional guidance. In some cases, a user provides a text prompt (e.g., text prompt 1060) describing content to be included in a generated image. In some examples, guidance can be provided in a form other than text, such as via an image, a sketch, a color, a style, or a layout. The system converts text prompt 1060 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 1000 generates an image based on the noise map and the conditional guidance vector.

A diffusion process can include both a forward diffusion process 1030 for adding noise to an image (e.g., original image 1005) or features (e.g., original image feature 1020) in a latent space 1025 and a reverse diffusion process 1040 for denoising the images (or features) to obtain a denoised image (e.g., output image 1055). The forward diffusion process 1030 can be represented as q(xₜ|xₜ₋₁), and the reverse diffusion process 1040 can be represented as p_{θ}(xₜ₋₁|xₜ). Further detail on the diffusion process is described with reference to FIG. 12.

A diffusion model 1000 may be trained using both a forward diffusion process 1030 and a reverse diffusion process 1040. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1030 in N stages. In some cases, the forward diffusion process 1030 is a fixed process where Gaussian noise is successively added to an image. In latent diffusion models, the Gaussian noise may be successively added to features (e.g., original image feature 1020) in a latent space 1025.

At each stage n, starting with stage N, a reverse diffusion process 1040 is used to predict the image or image features at stage n−1. For example, the reverse diffusion process 1040 can predict the noise that was added by the forward diffusion process 1030, and the predicted noise can be removed from the image to obtain the predicted image. In some cases, an original image 1005 is predicted at each stage of the training process.

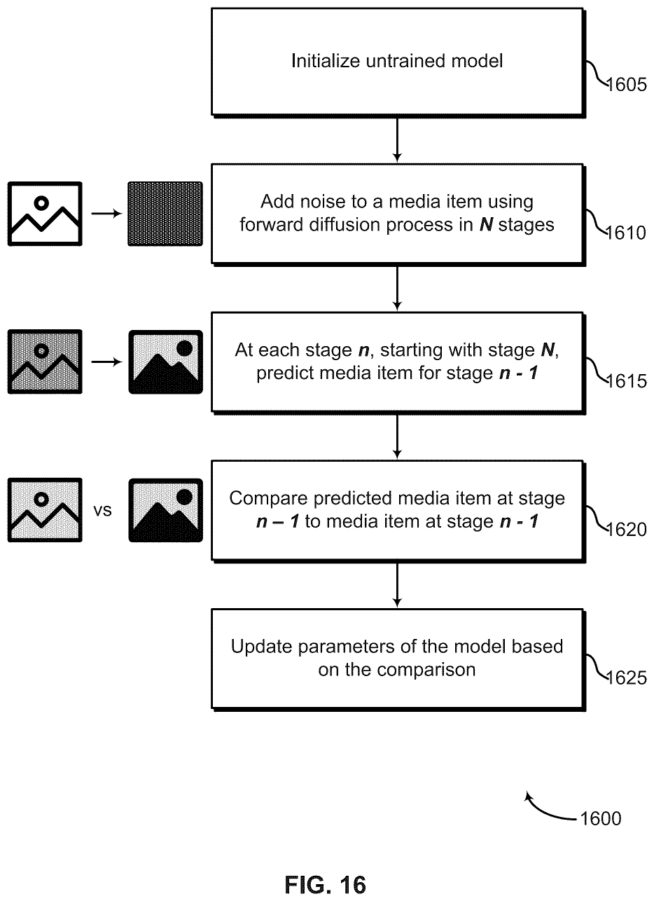

The training component (e.g., training component described with reference to FIG. 7) compares predicted image (or image features) at stage n−1 to an actual image (or image features), such as the image at stage n−1 or the original input image. For example, given observed data x, the diffusion model 1000 may be trained to minimize the variational upper bound of the negative log-likelihood −log p_{θ}(x) of the training data. The training component then updates parameters of the diffusion model 1000 based on the comparison. For example, parameters of a U-Net may be updated using gradient descent. Time-dependent parameters of the Gaussian transitions can also be learned. Further detail on training the diffusion model is described with reference to FIG. 16.

Original image 1005 is an example of, or includes aspects of, the corresponding element described with reference to FIG. 12. Forward diffusion process 1030 is an example of, or includes aspects of, the corresponding element described with reference to FIG. 12. Reverse diffusion process 1040 is an example of, or includes aspects of, the corresponding element described with reference to FIG. 12.

FIG. 11 shows an example of a U-Net 1100 architecture according to aspects of the present disclosure. The example shown includes U-Net 1100, input feature 1105, initial neural network layer 1110, intermediate feature 1115, down-sampling layer 1120, down-sampled feature 1125, up-sampling process 1130, up-sampled feature 1135, skip connection 1140, final neural network layer 1145, and output feature 1150.

In some examples, U-Net 1100 is an example of the component that performs the reverse diffusion process 1040 of diffusion model 1000 described with reference to FIG. 10 and includes architectural elements of the image generation model (e.g., the first image generation model 725 and the second image generation model 730) described with reference to FIG. 7. The U-Net 1100 depicted in FIG. 11 is an example of, or includes aspects of, the architecture used within the reverse diffusion process described with reference to FIG. 10.

In some examples, diffusion models are based on a neural network architecture known as a U-Net. The U-Net 1100 takes input feature 1105 having an initial resolution and an initial number of channels, and processes the input feature 1105 using an initial neural network layer 1110 (e.g., a convolutional network layer) to produce intermediate feature 1115. The intermediate feature 1115 is then down-sampled using a down-sampling layer 1120 such that the down-sampled feature 1125 has a resolution less than the initial resolution and a number of channels greater than the initial number of channels.

This process is repeated multiple times, and then the process is reversed. For example, the down-sampled feature 1125 is up-sampled using up-sampling process 1130 to obtain up-sampled feature 1135. The up-sampled feature 1135 can be combined with intermediate feature 1115 having the same resolution and number of channels via a skip connection 1140. These inputs are processed using a final neural network layer 1145 to produce output feature 1150. In some cases, the output feature 1150 has the same resolution as the initial resolution and the same number of channels as the initial number of channels.

In some cases, U-Net 1100 takes an additional input feature to produce conditionally generated output. For example, the additional input feature could include a vector representation of an input prompt. The additional input feature can be combined with the intermediate feature 1115 within the neural network at one or more layers. For example, a cross-attention module can be used to combine the additional input features and the intermediate feature 1115.

### Diffusion Process

FIG. 12 shows an example of a diffusion process 1200 according to aspects of the present disclosure. The example shown includes diffusion process 1200, forward diffusion process 1205, reverse diffusion process 1210, noisy image 1215, first intermediate image 1220, second intermediate image 1225, and original image 1230.

Diffusion process 1200 can include forward diffusion process 1205 for adding noise to original image 1230 (e.g., original image 1005 described with reference to FIG. 10) or features (e.g., original image feature 1020 described with reference to FIG. 10) in a latent space. In some aspects, diffusion process 1200 includes reverse diffusion process 1210 for denoising the noisy image 1215 (or image features) to obtain a denoised image (or original image 1230). The forward diffusion process 1205 can be represented as q(xₜ|xₜ₋₁), and the reverse diffusion process 1210 can be represented as p_{θ}(xₜ₋₁|xₜ). In some cases, the forward diffusion process 1205 is used during training to generate images with successively greater noise, and a neural network is trained to perform the reverse diffusion process 1210 (e.g., to successively remove the noise).

In an example forward diffusion process 1205 for a latent diffusion model (e.g., diffusion model 1000 described with reference to FIG. 10), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1210. During the reverse diffusion process 1210, the diffusion model begins with noisy data x_{T}, such as a noisy image 1215 and denoises the data to obtain the p_{θ}(xₜ₋₁|xₜ). At each step t−1, the reverse diffusion process 1210 takes xₜ, such as the first intermediate image 1220, and t as input. Here, t represents a step in the sequence of transitions associated with different noise levels. The reverse diffusion process 1210 outputs xₜ₋₁, such as the second intermediate image 1225, iteratively until x_{T} is reverted back to x₀, the original image 1230. The reverse diffusion process 1210 can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {Π}_{t = 1}^{T} {p}_{θ} ( {x}_{t - 1} \vert {x}_{t} ) , \qquad ( 2 )$$

where p(x)=N (x_{T}; 0, I) is the pure noise distribution as the reverse diffusion process 1210 takes the outcome of the forward diffusion process 1205, a sample of pure noise, as input and Πₜ₌₁^{T} p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

Forward diffusion process 1205 is an example of, or includes aspects of, the corresponding element described with reference to FIG. 10. Reverse diffusion process 1210 is an example of, or includes aspects of, the corresponding element described with reference to FIG. 10. Original image 1230 is an example of, or includes aspects of, the corresponding element described with reference to FIG. 10.

### Training and Evaluation

In FIGS. 13-16, a method, apparatus, non-transitory computer readable medium, and system for training a machine learning model include obtaining a training set comprising an input image including an element, generating, using a teacher image generation model, a predicted image that replaces the element from the input image with generated content, and training, using the training set and the predicted image, a first image generation model to replace the element from the input image with the generated content.

Some examples of the method, apparatus, non-transitory computer readable medium, and system further include training the teacher image generation model to replace the element from the input image. Some examples of the method, apparatus, non-transitory computer readable medium, and system further include training a second image generation model to replace the element from the input image based on an output of the first image generation model.

Some examples of the method, apparatus, non-transitory computer readable medium, and system further include computing a diffusion loss. Some examples further include updating parameters of the first image generation model based on the diffusion loss. In some aspects, the first image generation model has fewer parameters than the teacher image generation model.

According to some aspects, some examples of the method, apparatus, non-transitory computer readable medium, and system further include training the teacher image generation model to remove the element from the input image. Some examples of the method, apparatus, non-transitory computer readable medium, and system further include obtaining a ground-truth image comprising a removal of the element from the input image, wherein the teacher image generation model is trained based on the ground-truth image.

Some examples of the method, apparatus, non-transitory computer readable medium, and system further include computing a diffusion loss. Some examples further include updating parameters of the first image generation model based on the diffusion loss. Some examples of the method, apparatus, non-transitory computer readable medium, and system further include training a second image generation model to remove the element from the input image based on an output of the first image generation model. In some aspects, the first image generation model has fewer parameters than the teacher image generation model.

FIG. 13 shows an example of a method 1300 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system obtains a training set including an input image including an element. In some cases, the operations of this step refer to, or may be performed by, a training component as described with reference to FIG. 7. In some cases, the training set is stored in the databased as described with reference to FIG. 1.

At operation 1310, the system generates, using a teacher image generation model, a predicted image that replaces the element from the input image with generated content. In some cases, the operations of this step refer to, or may be performed by, a teacher image generation model as described with reference to FIGS. 7, 9, and 14. In some cases, the teacher image generation model is a complex, high-capacity image generation model trained on a large dataset. The teacher image generation model is trained to remove one or more elements from an input image to generate a predicted image without the element. In some cases, the teacher image generation model is trained to inpaint the removal region with pixels consistent with pixels surrounding the removal region.

At operation 1315, the system trains, using the training set and the teacher image generation model, a first image generation model to remove the element from the input image. In some cases, the operations of this step refer to, or may be performed by, a training component as described with reference to FIG. 7. In some cases, a diffusion loss is computed based on the predicted image and a ground-truth image. In some cases, the parameters of the first image generation model are updated based on the diffusion loss. Further detail on training the first image generation model is described with reference to FIG. 14.

FIG. 14 shows an example of training a machine learning model according to aspects of the present disclosure. The example shown includes training system 1400, low-resolution input 1405, first image generation model 1410, proxy guidance 1415, teacher image generation model 1420, input image 1425, second image generation model 1430, and synthetic image 1435.

Referring to FIG. 14, first image generation model 1410 receives low-resolution input 1405 (e.g., a low-resolution image) to generate a low-resolution output image (e.g., proxy guidance 1415). Teacher image generation model 1420 distillates knowledge from teacher image generation model 1420 to first image generation model 1410. In some cases, first image generation model 1410 is a smaller model (and has fewer parameters) compared to the teacher image generation model 1420. In some cases, a diffusion loss is computed based on the low-resolution output image and a ground-truth low-resolution image to finetune the first image generation model 1410.

In some embodiments, second image generation model 1430 receives input image 1425 and proxy guidance 1415 to generate synthetic image 1435. In some cases, input image 1425 is a high-resolution image. In some cases, synthetic image 1435 is a high-resolution image depicting the input image 1425 without the object indicated by, for example, an input mask. In one aspect, second image generation model 1430 has more parameters than first image generation model 1410. For example, a diffusion loss is computed based on synthetic image 1435 and a ground-truth image depicting the removed object, and the diffusion loss is used to finetune second image generation model 1430.

First image generation model 1410 is an example of, or includes aspects of, the corresponding element described with reference to FIGS. 7-9. Proxy guidance 1415 is an example of, or includes aspects of, the corresponding element described with reference to FIGS. 8 and 9. Teacher image generation model 1420 is an example of, or includes aspects of, the corresponding element described with reference to FIGS. 7 and 9.

Input image 1425 is an example of, or includes aspects of, the corresponding element described with reference to FIGS. 3-5, 8, and 9. Second image generation model 1430 is an example of, or includes aspects of, the corresponding element described with reference to FIGS. 7-9. Synthetic image 1435 is an example of, or includes aspects of, the corresponding element described with reference to FIG. 9.

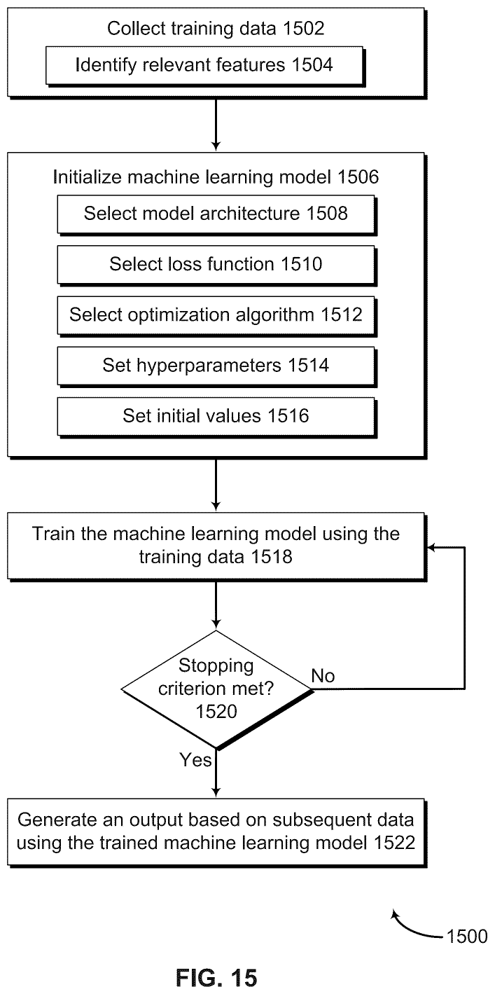

FIG. 15 shows an example of a flow diagram depicting an algorithm as a step-by-step procedure in an example implementation of operations performable for training a machine learning model according to aspects of the present disclosure. In some embodiments, the procedure 1500 describes an operation of the training component 735 described for configuring the first image generation model 725 and/or the second image generation model 730 as described with reference to FIG. 7. The procedure 1500 provides one or more examples of generating training data, use of the training data to train a machine-learning model, and use of the trained machine-learning model to perform a task.

To begin in this example, a machine-learning system collects training data (block 1502) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1506). Initialization of the machine-learning model includes selecting a model architecture (block 1508) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1510). The loss function is utilized to measure a difference between an output of the machine-learning model (e.g., the model predictions) and target values (e.g., as expressed by the training data) to be used to train the machine-learning model. Additionally, an optimization algorithm is selected (block 1512) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1516) examples of which include initializing weights and biases of nodes to increase efficiency in training and computational resources consumption as part of training. Hyperparameters are also set (block 1514) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1520), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1520), procedure 1500 continues the training of the machine-learning model using the training data (block 1518) in this example.

If the stopping criterion is met (“yes” from decision block 1520), the trained machine-learning model is then utilized to generate an output based on subsequent data (block 1522). The trained machine-learning model, for instance, is trained to perform a task as described above and therefore once trained is configured to perform that task based on subsequent data received as an input and processed by the machine-learning model.

FIG. 16 shows an example of a method 1600 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1600 describes an operation of the training component 735 described for training the machine learning model 720 as described with reference to FIG. 7. The method 1600 represents an example for training a reverse diffusion process as described above with reference to FIG. 12. In some examples, these operations are performed by a system including a processor executing a set of codes to control functional elements of an apparatus, such as the first image generation model and the second image generation model described in FIG. 7.

At operation 1605, the system initializes untrained model. In some cases, the operations of this step refer to, or may be performed by, a training component as described with reference to FIG. 7. Initialization can include defining the architecture of the model and establishing initial values for the model parameters. In some cases, the initialization can include defining hyper-parameters such as the number of layers, the resolution and channels of each layer block, the location of skip connections, and the like.

At operation 1610, the system adds noise to media item using forward diffusion process in N stages. In some cases, the operations of this step refer to, or may be performed by, a training component as described with reference to FIG. 7. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1615, the system at each stage n, starting with stage N, predict media item for stage n−1. In some cases, the operations of this step refer to, or may be performed by, a training component as described with reference to FIG. 7. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1620, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 7. For example, given observed data x, the diffusion model may be trained to minimize the variational upper bound of the negative log-likelihood −log p_{θ}(x) of the training data.

At operation 1625, the system updates parameters of the model based on the comparison. In some cases, the operations of this step refer to, or may be performed by, a training component as described with reference to FIG. 7. For example, parameters of a U-Net may be updated using gradient descent. Time-dependent parameters of the Gaussian transitions can also be learned.

### Computing Device

FIG. 17 shows an example of a computing device 1700 according to aspects of the present disclosure. The example shown includes computing device 1700, processor 1705, memory subsystem 1710, communication interface 1715, I/O interface 1720, user interface component 1725, and channel 1730.

In some embodiments, computing device 1700 is an example of, or includes aspects of, the image processing apparatus described with reference to FIGS. 1 and 7. In some embodiments, computing device 1700 includes processor 1705 that can execute instructions stored in memory subsystem 1710 to obtain an input image and an input mask, generate an intermediate result based on the input image and the input mask, and generate a synthetic image based on the input image and the intermediate result.

According to some embodiments, processor 1705 includes one or more processors. In some cases, processor 1705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1705 is configured to operate a memory array using a memory controller. In other cases, a memory controller is integrated into processor 1705. In some cases, processor 1705 is configured to execute computer-readable instructions stored in a memory to perform various functions. In some embodiments, processor 1705 includes special-purpose components for modem processing, baseband processing, digital signal processing, or transmission processing. Processor 1705 is an example of, or includes aspects of, the processor unit described with reference to FIG. 7.

According to some embodiments, memory subsystem 1710 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1710 is an example of, or includes aspects of, the memory unit described with reference to FIG. 7.

According to some embodiments, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1715.

According to some embodiments, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or hardware components controlled by the I/O controller. I/O interface 1720 is an example of, or includes aspects of, the I/O module described with reference to FIG. 7.

According to some embodiments, user interface component 1725 enables a user to interact with computing device 1700. In some cases, user interface component 1725 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIGS. 3-5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and an input mask, wherein the input mask indicates a region of the input image to be modified;
generating, using a first image generation model, an intermediate result based on the input image and the input mask, wherein the intermediate result modifies the region of the input image indicated by the input mask; and
generating, using a second image generation model, a synthetic image based on the input image and the intermediate result, wherein the synthetic image depicts the input image with content from the modified region at a higher level of detail than the intermediate result.

2. The method of claim 1, wherein obtaining the input mask comprises:
segmenting the input image to identify an element of the input image.

3. The method of claim 1, wherein obtaining the input mask comprises:
receiving a location input; and
generating the input mask based on the location input.

4. The method of claim 1, further comprising:
receiving a removal prompt, wherein the removal prompt comprises a command to remove an element from the input image; and
selecting a removal mode based on the removal prompt, wherein the intermediate result is based on the removal mode.

5. The method of claim 1, wherein:
the intermediate result comprises an intermediate image having a lower resolution than the synthetic image.

6. The method of claim 1, wherein:
the input mask indicates an element of the input image and the synthetic image removes the element from the input image.

7. The method of claim 1, wherein generating the intermediate result comprises:
obtaining a first noise input; and
denoising the first noise input to obtain the intermediate result.

8. The method of claim 1, wherein generating the synthetic image comprises:
obtaining a second noise input; and
denoising the second noise input to generate the synthetic image.

9. The method of claim 1, wherein generating the synthetic image comprises:
inpainting the region indicated by the input mask with content consistent with the input image.

10. The method of claim 1, wherein:
the first image generation model is trained to remove an image element using a predicted image generated by a teacher image generation model.

11. The method of claim 10, wherein:
the second image generation model is trained to replace the element from the input image based on an output of the first image generation model.

12. A non-transitory computer readable medium storing code for image processing, the code comprising instructions that, when executed by at least one processor, cause the at least one processor to perform operations comprising:
obtaining an input image and an input mask, wherein the input mask indicates an element of the input image to be removed;
generating, using a first image generation model, an intermediate result based on the input image and the input mask, wherein the intermediate result removes the element of the input image indicated by the input mask; and
generating, using a second image generation model, a synthetic image based on the input image and the intermediate result, wherein the synthetic image depicts the input image without the element removed in the intermediate result.

13. The non-transitory computer readable medium of claim 12, the operations further comprising:
receiving a removal prompt, wherein the removal prompt comprises a command to remove an element from the input image; and
selecting a removal mode based on the removal prompt, wherein the intermediate result is based on the removal mode.

14. The non-transitory computer readable medium of claim 12, wherein:
the first image generation model is trained to remove the element using a predicted image generated by a teacher image generation model.

15. The non-transitory computer readable medium of claim 12, wherein the first image generation model is trained by computing a diffusion loss and updating parameters of the first image generation model based on the diffusion loss.

16. The non-transitory computer readable medium of claim 12, wherein the second image generation model is trained to replace the element from the input image based on an output of the first image generation model.

17. A system comprising:
a memory component;
a processing device coupled to the memory component, the processing device configured to perform operations comprising:
obtaining an input image and an input mask, wherein the input image depicts an element and the input mask indicates a region of the element in the input image;
generating, using a first image generation model, an intermediate result based on the input image and the input mask, wherein the intermediate result includes first generated content in place of the element within the region indicated by the input mask; and
generating, using a second image generation model, a synthetic image based on the input image and the intermediate result, wherein the synthetic image includes second generated content in place of the element within the region indicated by the input mask.

18. The system of claim 17, further comprising:
a teacher image generation model, wherein the teacher image generation model is trained to remove the element from the input image.

19. The system of claim 17, wherein:
the first image generation model and the second image generation model are diffusion models.

20. The system of claim 17, wherein:
the first image generation model has fewer parameters than the second image generation model.
